(19) United States
(12) Patent Application Publication
(10) Pub. No.: US 2025/0362748 A1
(43) Pub. Date: Nov. 27, 2025

(54) PRESENTATION SYSTEM, PRESENTATION METHOD, AND PRESENTATION PROGRAM

(71) Applicant: NIPPON TELEGRAPH AND TELEPHONE CORPORATION, Tokyo (JP)

(72) Inventors: Takahiro KUSABUKA, Tokyo (JP); Hiroshi CHIGIRA, Tokyo (JP)

(73) Assignee: NIPPON TELEGRAPH AND TELEPHONE CORPORATION, Tokyo (JP)

(21) Appl. No.: 18/867,803

(22) PCT Filed: May 25, 2022
(86) PCT No.: PCT/JP2022/021467

§ 371 Date: Nov. 21, 2024

(51) Int. Cl. G06F 3/01

(52) U.S. Cl. CPC G06F 3/015; G06F 3/012; G06F 3/013

(57) ABSTRACT

A presentation system according to the present disclosure includes an acquisition unit, a determination unit, and a presentation unit. The acquisition unit acquires apparatus data indicating a plurality of apparatuses that a user can operate. Then, the acquisition unit acquires user data for specifying a field of view of a user. The determination unit determines an apparatus within a visual field of a user from among the plurality of apparatuses using the apparatus data and the user data. The presentation unit presents a visual pattern on the apparatus determined by the determination unit, the visual pattern enabling a brain wave of the user to operate the apparatus determined.

### TECHNICAL FIELD

The present invention relates to a presentation system, a presentation method, and a presentation program.

### BACKGROUND ART

Various User Interfaces (UI) are used to operate apparatuses such as computers and the Internet of Things (IoT) apparatuses. Generally, the user operates a graphical user interface (GUI) using a mouse or a touch screen. UI research is creating methods of operating apparatuses without using hands. A brain computer interface allows a user to operate an apparatus using the brain of the user. The brain computer interface may be implemented using steady state visually evoked potential (SSVEP).

Methods using SSVEP include methods for presenting action options to users. In this method, the mental state of the user is determined from the observation of the SSVEP of the user. Then, an option of the action is presented based on the mental state of the user.

### CITATION LIST

### Patent Literature

[PTL 1] Japanese Patent Application Publication No. 2010-233719

### SUMMARY OF INVENTION

### Technical Problem

However, there may be a difficulty in the prior art described above in enabling a user to operate an apparatus in space using brain waves of the user.

Therefore, the present disclosure provides a presentation system, a presentation method, and a presentation program that enable a user to operate an apparatus in a space using brain waves of the user.

### Solution to Problem

In one aspect of the present disclosure, a presentation system includes a first acquisition unit that acquires apparatus data indicating a plurality of apparatuses that can be operated by a user, a second acquisition unit that acquires user data specifying a field of view of the user, a determination unit that determines an apparatus within a field of view of the user from among the plurality of apparatuses using the apparatus data and the user data, and a presentation unit that presents a visual pattern on the apparatus determined by the determination unit, the visual pattern enabling a brain wave of the user to operate the apparatus determined.

### Advantageous Effects of Invention

The presentation system can allow a user to operate an apparatus in a space using brain waves of the user.

### BRIEF DESCRIPTION OF DRAWINGS

FIG. 1 is a block diagram of an example of an environment for visual pattern presentation.

FIG. 2 illustrates an outline of one visual pattern presentation processing according to the present disclosure.

FIG. 3 is a block diagram illustrating an example of a configuration of a presentation system according to the present disclosure.

FIG. 4 illustrates an example of configurations of a control unit and a storage unit according to the present disclosure.

FIG. 5 illustrates an example of a problem associated with visual pattern presentation.

FIG. 6A illustrates an example of visual pattern presentation processing according to the present disclosure.

FIG. 6B illustrates an example of the visual pattern presentation processing according to the present disclosure.

FIG. 7 is a flowchart illustrating an example of processing for determining an apparatus to be targeted for visual stimulus projection.

FIG. 8 illustrates an example of a hardware configuration of a computer.

### DESCRIPTION OF EMBODIMENTS

A plurality of embodiments of the present disclosure are described in the accompanying drawings and in the following description. Note that the present invention is not limited to these embodiments. A plurality of features of various embodiments may be combined in various ways under the conditions that these plurality of features are not contradictory to each other. The same symbols indicates the same elements.

The following description has ten sections:
1. Introduction
2. Environment for Visual Pattern Presentation
3. Outline of Visual Pattern Presentation Processing
4. Configuration of Presentation System
5. Detail of Visual Pattern Presentation Processing
5-1. Examples of Problems
5-2. Presentation of Visual Stimulation Pattern in Real Space
5-3. Examples of Other Implementations
6. Flowchart of Visual Pattern Presentation Processing
7. Effects
8. Hardware Configuration
9. Summary of Embodiments
10. Supplement

### 1. Introduction

A steady state visually evoked potential (SSVEP) is used to operate a GUI on a display. In a method using SSVEP, a target watched by a user is estimated based on brain waves of the user. When the retina is excited by visual stimulation of 3.5 Hz to 75 Hz, brain waves are detected. The frequency of the brain wave is equivalent to that of the visual stimulation.

The SSVEP technique does not require long-term training. In addition, the method using the SSVEP has a high information transfer rate (ITR) (ITR is one of the main indicators of brain-computer interface). For this reason, the method using the SSVEP is attracting attention as a UI for a handicapped person.

The SSVEP is easier to calibrate as compared to an approach of image analysis. In addition, the method using the SSVEP can accurately estimate the target of interest among several options. Further, the SSVEP has no problem of resolution in the camera. The SSVEP is robust with respect to factors such as distance to the user, user posture, individual differences (for example, a size of the iris eye, whether wearing glasses), and ambient light.

The SSVEP has the advantages described above, and the SSVEP is applied to the operation of the GUI. For example, the GUI is a button displayed on a display. The SSVEP is also applied to GUI operation in a virtual reality (VR). For example, a button is displayed in the VR.

Methods for operating the GUI using the SSVEP may be used to operate objects placed in a plane, such as an array of buttons. However, such a method does not assume an object arranged in a space.

On the other hand, as IoT technology has developed, various computer apparatuses have been used in many scenes. The computer apparatuses such as the IoT apparatuses are used in the real world. These apparatuses are arranged in a “space” such as a room. As described above, the method for operating the GUI using the SSVEP does not consider the application of the SSVEP to the “object in a space”. Therefore, such a method is difficult to apply the SSVEP to the operation of an apparatus disposed in a space.

In order to solve the above problem, the presentation system according to the present disclosure performs one or more visual pattern presentation processing described below.

### 2. Environment for Visual Pattern Presentation

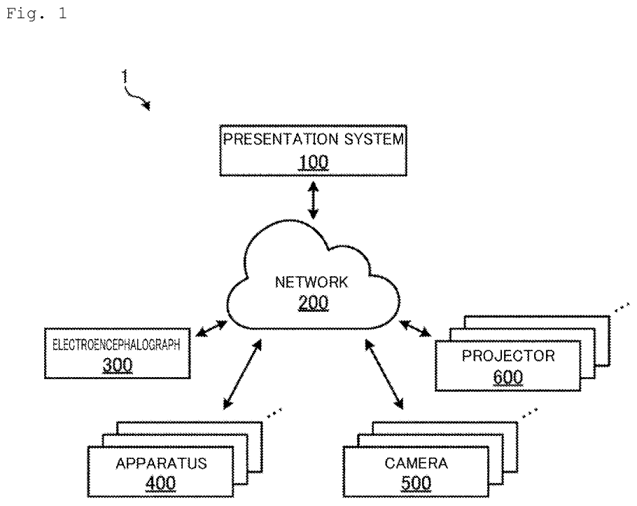

First, an environment for presenting a visual pattern will be described with reference to FIG. 1.

FIG. 1 is a block diagram of an environment 1 which is an example of an environment for visual pattern presentation. As illustrated in FIG. 1, the environment 1 includes a presentation system 100, a network 200, an electroencephalograph 300, a plurality of apparatuses 400, a plurality of cameras 500, and a plurality of projectors 600.

The presentation system 100 is a system for performing processing for presenting a visual pattern. In this specification, such processing is called visual pattern presentation processing. The outline of one visual pattern presentation processing will be described in Section 3. Various visual pattern presentation processing will be described in detail in Section 5.

The presentation system 100 includes one or more computers, such as one or more servers. An example of the configuration of the presentation system 100 will be described in Section 4.

The network 200 is, for example, a network such as a local area network (LAN), a wide area network (WAN), or the Internet. The network 200 connects the presentation system 100, the electroencephalograph 300, the apparatus 400, the camera 500, and the projector 600.

The electroencephalograph 300 is an electroencephalograph used by a user. The electroencephalograph 300 is, for example, a non-invasive electroencephalograph. The electroencephalograph 300 is used to measure the SSVEP.

The apparatus 400 is a variety of computer devices used by a user. The apparatus 400 is, for example, a residential IoT device such as a light, an air conditioner, or a television. For example, the apparatus 400 is placed in a room of a user.

The camera 500 is a camera installed in a location related to the user. The location is, for example, a user's room. The camera 500 may be installed near the apparatus 400.

The projector 600 is a projector installed near the apparatus 400. For example, the projector 600 is attached to a ceiling of a user's room.

### 3. Outline of Visual Pattern Presentation Processing

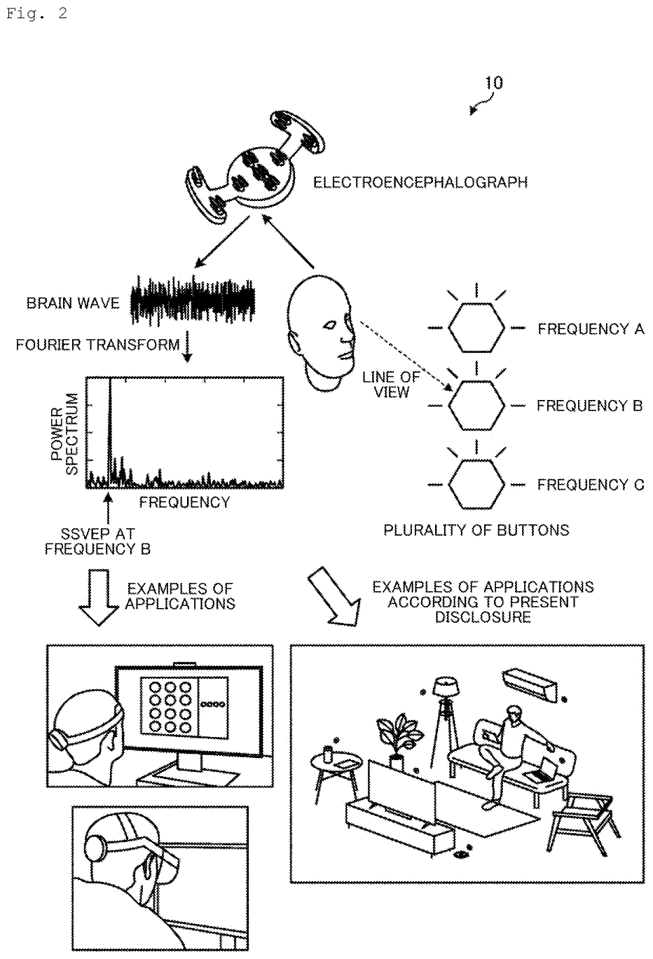

Next, an outline of one visual pattern presentation processing will be described with reference to FIG. 2. This outline is not intended to limit the present invention and the embodiments described in the following sections.

FIG. 2 illustrates an outline 10 which is an outline of one visual pattern presentation processing according to the present disclosure. The outline 10 is to compare the current application of the SSVEP with the application of the SSVEP according to the present disclosure.

As illustrated in FIG. 2, the SSVEP may be used to estimate a button of interest of a plurality of buttons. First, stimulation patterns are presented on respective buttons. For example, a button blinks at a frequency A and the other buttons blink at a frequency B. In the example illustrated in FIG. 2, the user pays attention to a button which blinks at the frequency B. The electroencephalograph measures the brain waves of a user. Then, a power spectrum is obtained by Fourier transform of the measured brain waves. The peak of the power spectrum corresponds to the SSVEP at the frequency B. That is, the SSVEP shows which stimulation pattern the user has viewed.

As described above, examples of the current application of the SSVEP include the GUI operation on a display and the GUI operation in the VR. If the resolution of the display is high, the user can accurately select the buttons arranged densely. The number of realistic stimulation patterns is about 10.

On the other hand, an example of the application of the SSVEP according to the present disclosure includes the operation of the IoT apparatus placed in a user's room. The presentation system 100 applies the SSVEP to the operation/selection of an apparatus in a space such as an IoT apparatus. The presentation system 100 presents the visual stimulation pattern to a location where the visual stimulation pattern is required when necessary. For example, if the user is directed toward the television, the presentation system 100 projects a visual stimulation pattern onto the television using the projector 600. Thus, the presentation system 100 allows a user to operate or select the apparatus in the space.

### 4. Configuration of Presentation System

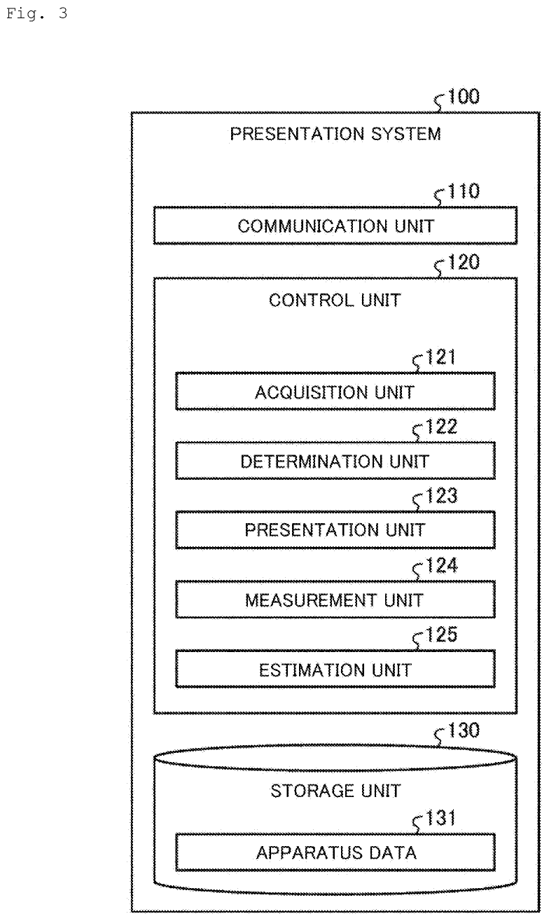

Next, an example of a configuration of the presentation system 100 will be described with reference to FIG. 3.

FIG. 3 is a block diagram illustrating an example of a configuration of the presentation system 100 according to the present disclosure. As illustrated in FIG. 3, the presentation system 100 includes a communication unit 110, a control unit 120, and a storage unit 130. The presentation system 100 may include an input unit (for example, a keyboard or a mouse) that receives an input from a manager of the presentation system 100. In addition, the presentation system 100 may include an output unit (for example, a liquid crystal display or an organic electroluminescence (EL) display) that displays information to the manager.

### (Communication Unit 110)

The communication unit 110 is implemented by a network apparatus such as a network interface card (NIC). The communication unit 110 is connected to the network 200 in wired or wireless manner. The communication unit 110 can transmit and receive data to and from the electroencephalograph 300, the apparatus 400, the camera 500, and the projector 600 via the network 200.

### (Control Unit 120)

The control unit 120 is implemented by the data processing device and various programs stored in the storage device. The data processing device is, for example, a processor such as a central processing unit (CPU), a micro processing unit (MPU), or a general purpose graphic processing unit (GPGPU). The control unit 120 may be implemented as a controller for controlling a plurality of operations of the presentation system 100. For example, when one or more processors use a random access memory (RAM) as a work area, in a case where a program (a plurality of instructions) is executed, one or more processors perform multiple operations.

### (Storage Unit 130)

The storage unit 130 is implemented using a RAM, a semiconductor memory such as a flash memory, a magnetic disk such as a hard disk, or an optical disc. The storage unit 130 stores various types of programs and various types of data.

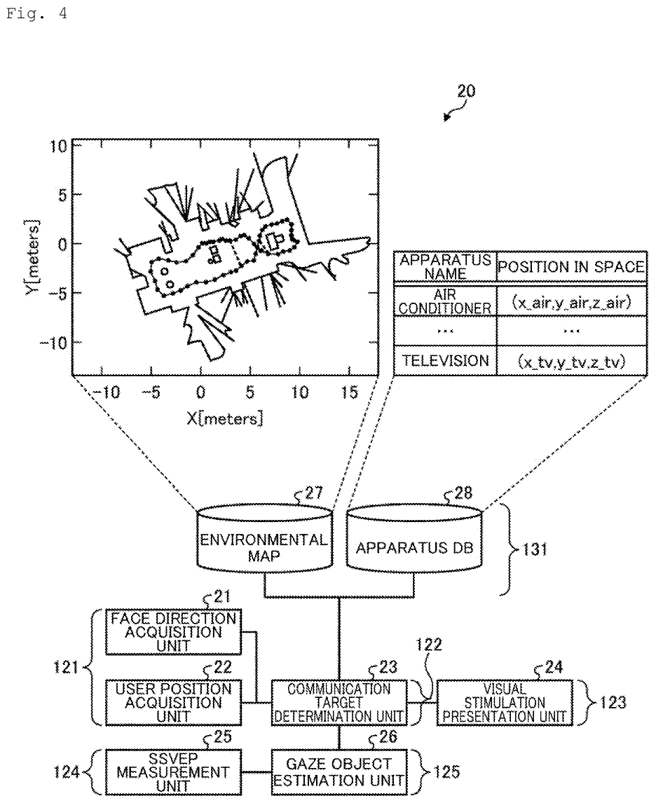

As illustrated in FIG. 3, the control unit 120 includes an acquisition unit 121, a determination unit 122, and a presentation unit 123, a measurement unit 124, and an estimation unit 125. The acquisition unit 121 is an example of a first acquisition unit and a second acquisition unit. The data processing performed by the individual units will be described below. Further, details of the individual units will be described below with reference to FIG. 4.

### (Acquisition Unit 121)

The acquisition unit 121 acquires apparatus data related to the apparatus 400. The apparatus data indicates a plurality of apparatuses that can be operated by a user. For example, the plurality of apparatuses are the IoT apparatuses in a specific environment (for example, a user's room). In addition, the acquisition unit 121 also acquires user data related to the user. For example, the user data is an image or a video captured by the camera 500. The user data may indicate the position and the face direction of the user. The acquisition unit 121 can measure a visual line direction of the user (that is, a range viewed by the user) based on the user data.

### (Determination Unit 122)

The determination unit 122 determines an apparatus in a field of view of a user. Such an apparatus is, for example, an IoT apparatus located in the direction of the line of view of the user. For example, the determination unit 122 can determine a plurality of visual patterns corresponding to the plurality of apparatuses, respectively, based on a predetermined condition (for example, a specific rule) stored in a repository in the storage unit 130.

### (Presentation Unit 123)

The presentation unit 123 presents the visual pattern on the apparatus determined by the determination unit 122. For example, a plurality of different visual stimulation patterns are presented on the IoT apparatus in a direction of line of view of a user.

### (Measurement Unit 124)

The measurement unit 124 measures the brain waves of the user using the electroencephalograph 300. The measurement unit 124 can measure the SSVEP based on the brain waves of the user.

### (Estimation Unit 125)

The estimation unit 125 estimates an apparatus operated by the user based on data related to the brain waves of the user. For example, the estimation unit 125 specifies the apparatus operated by a user based on the SSVEP.

As illustrated in FIG. 3, the storage unit 130 includes apparatus data 131. The apparatus data 131 is various data related to the apparatus 400. Details of the apparatus data 131 will be described with reference to FIG. 4.

FIG. 4 illustrates a configuration 20 which is an example of the configurations of the control unit 120 and the storage unit 130 according to the present disclosure. As illustrated in FIG. 4, the configuration 20 includes a face direction acquisition unit 21, a user position acquisition unit 22, an imaging target determination unit 23, a visual stimulation presentation unit 24, an SSVEP measurement unit 25, a gazing target estimation unit 26, an environment MAP 27, and an apparatus DB 28. The face direction acquisition unit 21 and the user position acquisition unit 22 are examples of the acquisition unit 121. The imaging target determination unit 23 is an example of the determination unit 122. The visual stimulation presentation unit 24 is an example of the presentation unit 123. The SSVEP measurement unit 25 is an example of the measurement unit 124. The gazing target estimation unit 26 is an example of the estimation unit 125.

The environment MAP 27 and the apparatus DB 28 are examples of the apparatus data 131.

The face direction acquisition unit 21 acquires the face direction of the user. The direction is represented using, for example, an azimuth angle.

The user position acquisition unit 22 acquires a position of a user. The position is represented, for example, using coordinates.

The imaging target determination unit 23 determines a visual stimulation pattern to be projected and an apparatus to be projected of the visual stimulation pattern based on a position of a user, a face direction of the user, the environment MAP 27, and the apparatus DB 28. The imaging target determination unit 23 can acquire various visual stimulation patterns from a repository in the storage unit 130.

The visual stimulation presentation unit 24 presents a visual stimulation pattern. The visual stimulation presentation unit 24 can project the visual stimulation pattern using the projector 600.

The SSVEP measurement unit 25 measures the SSVEP data. The SSVEP measurement unit 25 can measure the SSVEP data using the electroencephalograph 300.

The gazing target estimation unit 26 estimates an object that a user gazes. For example, the gazing target estimation unit 26 estimates an apparatus gazed at by a user based on the SSVEP data, a visual stimulation target, and an apparatus on which the visual stimulation target is projected.

The environment MAP 27 indicates an environment where a user is present. The environment MAP 27 may indicate the positions of the camera 500 and the projector 600.

The apparatus DB 28 is a database for storing data of the apparatus 400. The apparatus DB 28 stores the apparatus name of the apparatus 400. The apparatus name is associated with a position in the space of the apparatus.

### 5. Detail of Visual Pattern Presentation Processing

The outline of one visual pattern presentation processing has been described above with reference to FIG. 2. Various visual pattern presentation processing will be described in detail with reference to this section.)

### 5-1. Examples of Problems

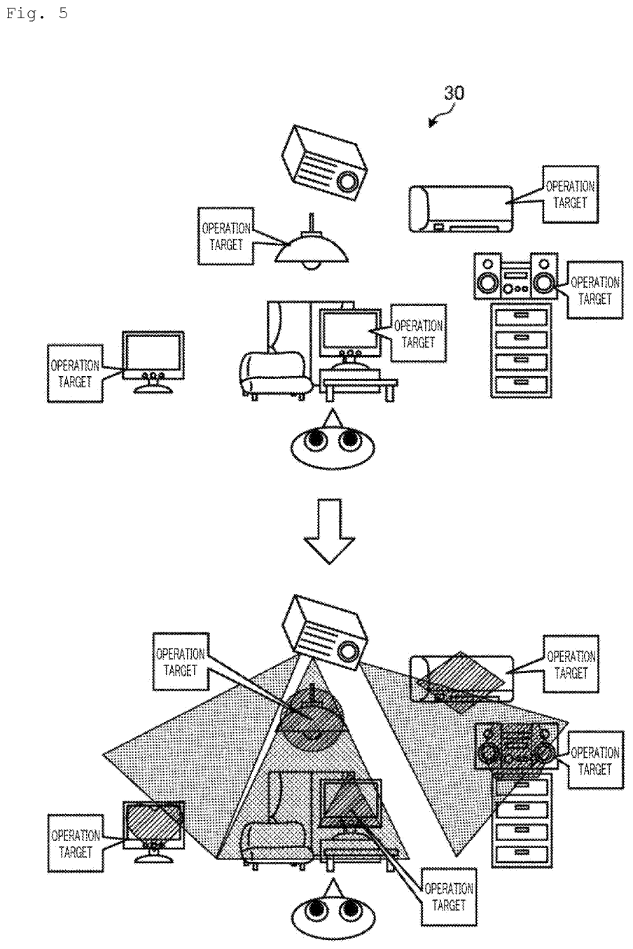

FIG. 5 illustrates a problem 30 which is an example of a problem associated with visual pattern presentation. In the example of FIG. 5, a system presents a visual pattern. The problem 30 is that the system deteriorates the estimation accuracy and analysis time of the SSVEP.

As illustrated in FIG. 5, when the SSVEP is applied to selection of the apparatus in a space, the system is required to constantly present visual stimulus patterns to all apparatuses that can be selected. However, preparation of a large amount of visual stimulation patterns used in the SSVEP gives adverse effects such as a decrease in estimation accuracy and an increase in analysis time to practical use. As described above, the number of stimulation patterns is usually about 10. Therefore, the presentation system 100 presents the visual stimulation pattern by a necessary amount when the visual stimulation pattern is required.

### 5-2. Presentation of Visual Stimulation Pattern in Real Space

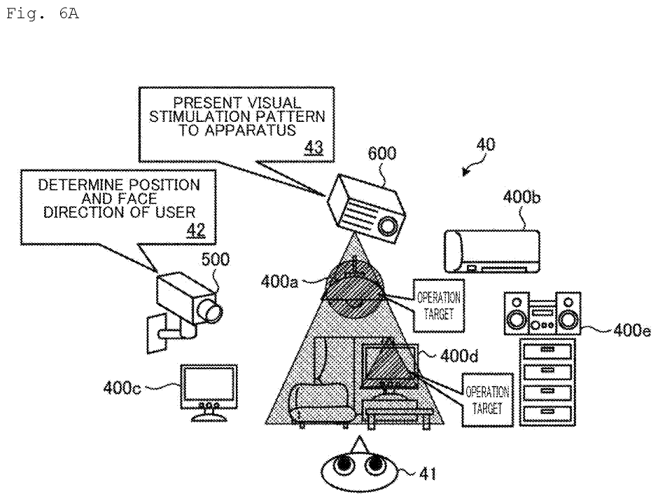

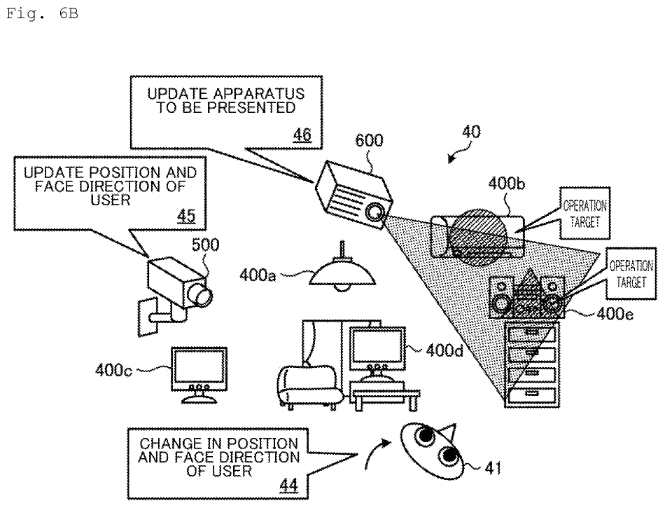

FIGS. 6A and 6B collectively illustrate visual pattern presentation processing 40, which is an example of visual pattern presentation processing according to the present disclosure. In the visual pattern presentation processing 40, the presentation system 100 presents a visual stimulation pattern based on the position and face direction of a user 41. The user 41 has an apparatus 400a, an apparatus 400b, an apparatus 400c, an apparatus 400d, and an apparatus 400e in the room of the user 41.

As illustrated in FIG. 6A, the acquisition unit 121 of the presentation system 100 estimates the position and face direction of the user 41 (42). For example, the acquisition unit 121 acquires a position and a head direction of the user 41 using the camera 500.

The presentation unit 123 of the presentation system 100 presents the visual stimulation pattern only to the options (for example, the apparatus 400a and the apparatus 400d) that exist in the direction that the user 41 is facing (43). For example, the presentation unit 123 projects the visual stimulation pattern on the apparatus 400 in the direction using the projector 600.

Referring to FIG. 6B, the acquisition unit 121 detects changes in the position and the face direction of the user 41 (44). Then, the acquisition unit 121 updates the position and the face direction of the user 41 (45). The presentation unit 123 updates the apparatus 400 to be presented (46). In this way, the user 41 directs the face toward the apparatus 400 (for example, the apparatus 400b and the apparatus 400e) desired to be operated by the user 41, then, when gazing at the visual stimulation pattern, the user 41 can select the apparatus 400 to be operated by the user 41.

### 5-3. Examples of Other Implementations

The visual pattern presentation processing according to the present disclosure may be applied to selection and operation of an apparatus in a VR space. In this case, the apparatus in the VR space corresponds to the apparatus 400 in FIG. 6A and FIG. 6B. That is, the presentation system 100 can be directed not only to the real-world apparatus but also to the VR-world apparatus.

The camera 500 may be integrated with the electroencephalograph 300. In this case, the presentation system 100 (for example, the acquisition unit 121) may specify an apparatus watched by the user based on an image captured by the camera 500. In addition, the presentation system 100 (for example, the presentation unit 123) may display the visual stimulation pattern on a screen provided in the apparatus 400. The apparatus 400 may be connected to, for example, a screen.

### 6. Flowchart of Visual Pattern Presentation Processing

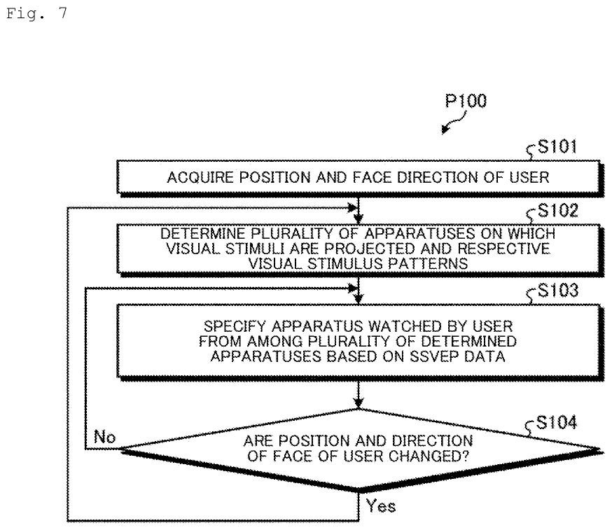

Next, a Flowchart of an example of the visual pattern presentation processing will be described with reference to FIG. 7. An example of visual pattern presentation processing includes processing for determining an apparatus to be a target of visual stimulus projection. The processing for determining the apparatus to be a target of visual stimulus projection is performed, for example, by the presentation system 100 of FIG. 1.

FIG. 7 is a flowchart illustrating processing P100, which is an example of processing for determining an apparatus to be a target of visual stimulus projection.

In the example of FIG. 7, the environment MAP 27 and the apparatus DB 28 described above with reference to FIG. 4 are prepared in advance. The environment MAP 27 is already created, and the apparatus DB 28 is also already registered.

The acquisition unit 121 acquires the position and the face direction of the user (step S101). For example, the face direction acquisition unit 21 acquires the face direction, and the user position acquisition unit 22 acquires the position of the user.

The determination unit 122 determines a plurality of apparatuses on which visual stimulation is projected and respective visual stimulation patterns (step S102). For example, the imaging target determination unit 23 determines the apparatus 400 that is the target of visual stimulation projection and its visual stimulation pattern based on the position of the user, the face direction of the user, the environment MAP 27, and the apparatus DB 28. The determined visual stimulation pattern is projected on the determined apparatus 400 by the presentation unit 123 (for example, a visual stimulation presentation unit 24). The SSVEP data is measured by the measurement unit 124 (for example, the SSVEP measurement unit 25).

The estimation unit 125 specifies an apparatus watched by a user from among the plurality of determined apparatuses based on the SSVEP data (step S103). For example, the gazing target estimation unit 26 estimates an apparatus watched by a user based on the SSVEP data and a projected visual stimulation pattern.

The acquisition unit 121 determines whether the position and face direction of the user have changed (step S104). In a case where it is determined that the position and the face direction of the user have changed (step S104: Yes), the acquisition unit 121 performs the step S102 again. In a case where it is determined that the position and face direction of the user have not changed (step S104: No), the estimation unit 125 performs step S103 again.

### 7. Effects

The presentation system 100 may project a visual stimulation pattern that allows visual manipulation of options in space (for example, the apparatus 400) using a projector. Since the presentation system 100 projects the visual stimulation pattern when the visual stimulation pattern is required, the presentation system 100 can suppress influence on the estimation accuracy and analysis time of the SSVEP.

### 8. Hardware Configuration

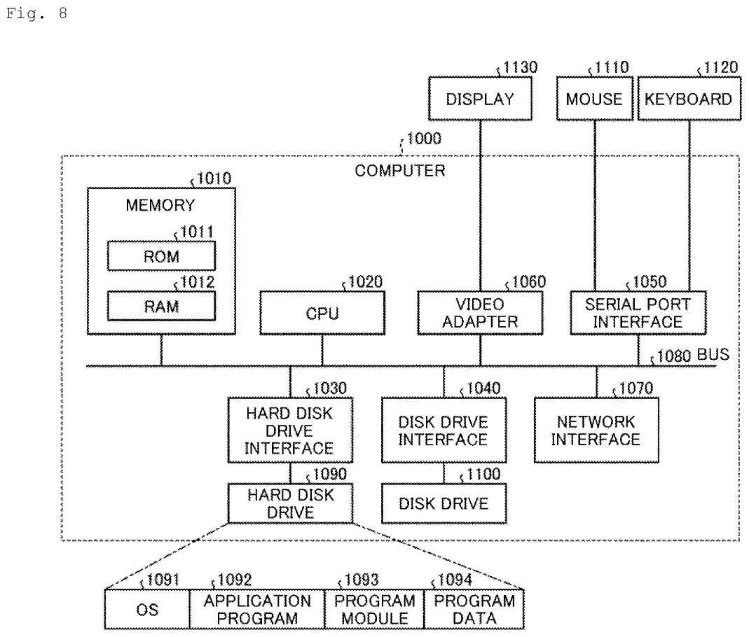

FIG. 8 is a diagram illustrating a computer 1000 which is an example of a hardware configuration of a computer. The system and methods described in the specification are implemented by, for example, a computer 1000.

The computer 1000 indicates an example of a computer in which the presentation system 100 is realized by the execution of a program. The computer 1000 includes a memory 1010 and a CPU 1020. In addition, the computer 1000 includes a hard disk drive interface 1030, a disk drive interface 1040, a serial port interface 1050, a video adapter 1060, and a network interface 1070. These units are connected by a bus 1080.

The memory 1010 includes a read only memory (ROM) 1011 and a RAM 1012. The ROM 1011 stores, for example, a boot program, such as a basic input output system (BIOS). The hard disk drive interface 1030 is connected to a hard disk drive 1090. The disk drive interface 1040 is connected to a disk drive 1100. A removable storage medium (for example, a magnetic disk or an optical disc) may be inserted into the disk drive 1100. The serial port interface 1050 is connected to, for example, a mouse 1110 and a keyboard 1120. The video adapter 1060 is connected to, for example, a display 1130.

The hard disk drive 1090 stores an OS 1091, an application program 1092, a program module 1093, and program data 1094. A program executed by the computer 1000 defines a plurality of operations of the presentation system 100. This program may be implemented as a program module 1093 written in code executable by the computer 1000. The program module 1093 is stored in, for example, the hard disk drive 1090. For example, the hard disk drive 1090 stores a program module 1093 for executing the same processing as the functions of the components of the presentation system 100. Note that the hard disk drive 1090 may be replaced with a solid state drive (SSD).

The hard disk drive 1090 can store a presentation program for visual pattern presentation processing. The hard disk drive 1090 may store a computer program product including a presentation program (a plurality of instructions). The presentation program executes one or a plurality of methods, as described above, when the presentation program is executed.

The setting data used for the various processing described above may be implemented as the program data 1094. The setting data is stored, for example, in the memory 1010 or the hard disk drive 1090. In addition, the CPU 1020 loads the program module 1093 and the program data 1094 stored in the memory 1010 or the hard disk drive 1090 onto the RAM 1012 as necessary. Then, the CPU 1020 performs various processing described above.

Note that the program module 1093 and program data 1094 may be stored in a removable storage medium instead of the hard disk drive 1090. The CPU 1020 may load the program module 1093 and the program data 1094 via the disk drive 1100 or the like. Alternatively, the program module 1093 and the program data 1094 may be stored in another computer connected to the computer 1000 via a network (LAN, WAN, etc.). In this case, the CPU 1020 may load the program module 1093 and the program data 1094 via the network interface 1070.

### 9. Summary of Embodiments

As described above, the presentation system 100 includes the acquisition unit 121, the determination unit 122, and the presentation unit 123. In at least one embodiment, the acquisition unit 121 acquires apparatus data indicating a plurality of apparatuses that a user can operate. Then, the acquisition unit 121 acquires user data for specifying a field of view of a user. In at least one embodiment, the determination unit 122 determines an apparatus within a user's field of view from among a plurality of apparatuses using the apparatus data and the user data. In at least one embodiment, the presentation unit 123 presents a visual pattern on the apparatus determined by the determination unit 122, the visual pattern allowing the user's brain waves to operate the determined apparatus.

In some embodiments, the determination unit 122 determines a plurality of apparatuses within a user's field of view from a plurality of apparatuses, and determines a plurality of visual patterns corresponding to the plurality of apparatuses, each visual pattern allowing the user's brain waves to operate the corresponding apparatus. In some embodiments, the presentation unit 123 presents each visual pattern on a corresponding apparatus.

In some embodiments, the presentation unit 123 projects the visual pattern onto the apparatus determined by the determination unit 122 using a projector located in the vicinity of the apparatus determined by the determination unit 122.

In some embodiments, the acquisition unit 121 acquires positions of a plurality of apparatuses that a user can operate as apparatus data.

In some embodiments, the acquisition unit 121 acquires the position of the user and the face direction of the user as user data.

In some embodiments, the acquisition unit 121 acquires the position of the user and the face direction of the user using a camera installed at a specific location associated with the user.

### 10. Supplement

Finally, the above description is supplemented by other embodiments. Various embodiments have been described above with reference to the drawings. These embodiments are exemplary and the above description is not intended to limit the present disclosure to these embodiments. The features described in this specification may be implemented in various ways, including variations and modifications based on the knowledge of those skilled in the art.

### (Various Modifications)

In this specification, several processes have been described as automatically performed processes. Some of these processing may be performed manually. Some other processing have also been described as manually performed processing.

All or some of other processing described above may be performed automatically according to known methods.

Various implementations of the presentation system 100 are described herein or illustrated in the drawings. Some implementations relate to information including various data, data processing procedures, specific names, or parameters. Such implementations may be optionally modified unless otherwise specified. For example, various data are not limited to the data shown in the drawings.

The components of the system are shown in the drawing. The illustrated components conceptually illustrate the functionality of the system. The components are not necessarily physically configured as illustrated in the drawings. The components may be integrated or distributed, and a specific form of the system is not limited to the illustrated form. All or some of the system may be functionally or physically distributed or integrated depending on various loads and usage situations.

### (Terms Representing Components)

The term unit (module, section, -er suffix or -or suffix) can be read as unit, means, circuit, etc. For example, the communication module, the control module, and the storage module include can be read as a communication unit, a control unit, and a storage unit.

### (Configuration of Control Unit)

The configuration of the control unit 120 illustrated in FIG. 3 is exemplary, and the data processing described with respect to a specific unit does not necessarily have to be performed by that specific unit. For example, the presentation unit 123 may perform the data processing described with respect to the determination unit 122. Also, the control unit 120 may include other units not shown in FIG. 3. The other units may perform the data processing described with respect to the control unit 120.

### (Data Processing Device)

The data processing device described with respect to the control unit 120 is not limited to the specific hardware described above. The data processing device may be, for example, a variety of computers or an integrated circuit such as an application specific integrated circuit (ASIC), a field programmable gate array (FPGA), or a general purpose graphic processing unit (GPGPU).

### REFERENCE SIGNS LIST

1 Environment
100 Presentation system
110 Communication unit
120 Control unit
121 Acquisition unit
122 Determination unit
123 Presentation unit
124 Measurement unit
125 Estimation unit
130 Storage unit
131 Apparatus data
200 Network
300 Electroencephalograph
400 Apparatus
500 Camera
600 Projector

1. A presentation system comprising a processor configured to execute operations comprising:
acquiring apparatus data indicating a plurality of apparatuses that can be operated by a user;
acquiring user data specifying a field of view of the user;
determining an apparatus within a field of view of the user from among the plurality of apparatuses using the apparatus data and the user data; and
presenting a visual pattern on the apparatus, the visual pattern enabling a brain wave of the user to operate the apparatus determined.

2. The presentation system according to claim 1, wherein the determining further comprises determining a plurality of apparatuses within a field of view of the user from the plurality of apparatuses, and determining a plurality of visual patterns respectively corresponding to the plurality of apparatuses, each visual pattern enabling the brain wave of the user to operate the corresponding apparatus; and
the presenting further comprises presenting the respective visual patterns on the corresponding apparatus.

3. The presentation system according to claim 1, wherein the presenting further comprises projecting the visual pattern on the apparatus using a projector positioned in the vicinity of the apparatus.

4. The presentation system according to claim 1, wherein the acquiring apparatus data further comprises acquiring positions of the plurality of apparatuses that the user can operate as the apparatus data.

5. The presentation system according to claim 1, wherein the acquiring user data further comprises acquiring a position of the user and a direction of a face of the user as the user data.

6. The presentation system according to claim 5, wherein the acquiring user data further comprises acquiring the position of the user and the direction of the face of the user using a camera installed at a specific place associated with the user.

7. A presentation method executed by a computer, the method comprising:
a first acquisition process of acquiring apparatus data indicating a plurality of apparatuses that can be operated by a user;
a second acquisition process of acquiring user data specifying a field of view of the user;
a determination process of determining a device within a field of view of the user from among the plurality of apparatuses using the apparatus data and the user data, and
a presentation process of presenting a visual pattern on the apparatus determined in the determination process, the visual pattern enabling a brain wave of the user to operate the apparatus determined.

8. (canceled)

9. The presentation method according to claim 7, wherein a plurality of apparatuses within a field of view of the user is determined from the plurality of apparatuses, and a plurality of visual patterns respectively corresponding to the plurality of apparatuses is determined, each visual pattern enabling the brain wave of the user to operate the corresponding apparatus; and
the respective visual patterns are presented on the corresponding apparatus.

10. The presentation method according to claim 7, wherein the visual pattern is projected on the apparatus using a projector positioned in the vicinity of the apparatus.

11. The presentation method according to claim 7, wherein positions of the plurality of apparatuses are acquired such that the user can operate as the apparatus data.

12. The presentation method according to claim 7, wherein a position of the user and a direction of a face of the user are acquired as the user data.

13. The presentation method according to claim 12, wherein the position of the user and the direction of the face of the user are acquired using a camera installed at a specific place associated with the user.

14. A computer-readable non-transitory recording medium storing computer-executable program instructions that when executed by a processor cause a computer to execute a presentation method comprising:
a first acquisition process of acquiring apparatus data indicating a plurality of apparatuses that can be operated by a user;
a second acquisition process of acquiring user data specifying a field of view of the user;
a determination process of determining a device within a field of view of the user from among the plurality of apparatuses using the apparatus data and the user data, and
a presentation process of presenting a visual pattern on the apparatus determined in the determination process, the visual pattern enabling a brain wave of the user to operate the apparatus determined.

15. The computer-readable non-transitory recording medium according to claim 14 wherein the presentation method further comprises:
a plurality of apparatuses within a field of view of the user is determined from the plurality of apparatuses, and a plurality of visual patterns respectively corresponding to the plurality of apparatuses is determined, each visual pattern enabling the brain wave of the user to operate the corresponding apparatus; and
the respective visual patterns are presented on the corresponding apparatus.

16. The computer-readable non-transitory recording medium according to claim 14 wherein the presentation method further comprises:
the visual pattern is projected on the apparatus using a projector positioned in the vicinity of the apparatus.

17. The computer-readable non-transitory recording medium according to claim 14 wherein the presentation method further comprises:
positions of the plurality of apparatuses are acquired such that the user can operate as the apparatus data.

18. The computer-readable non-transitory recording medium according to claim 14 wherein the presentation method further comprises:
a position of the user and a direction of a face of the user are acquired as the user data.

19. The computer-readable non-transitory recording medium according to claim 18 wherein the presentation method further comprises: the position of the user and the direction of the face of the user are acquired using a camera installed at a specific place associated with the user.
